(19) United States
(12) Patent Application Publication
(10) Pub. No.: US 2025/0087924 A1
(43) Pub. Date: Mar. 13, 2025

(54) CONNECTOR

(71) Applicant: SUMITOMO WIRING SYSTEMS, LTD., Mie (JP)

(72) Inventor: Atsuya IKEDA, Mie (JP)

(21) Appl. No.: 18/728,458

(22) PCT Filed: Jan. 10, 2023
(86) PCT No.: PCT/JP2023/000263

§ 371 Date: Jul. 12, 2024

(30) Foreign Application Priority Data
Jan. 18, 2022 (JP) 2022-005762

(51) Int. Cl. H01R 13/41; H01R 12/70; H01R 13/629

(52) U.S. Cl. CPC H01R 13/41; H01R 12/707; H01R 12/7082; H01R 13/62977; H01R 13/62994

(57) ABSTRACT

A housing body includes a small cavity portion for accommodating small-size second terminal fittings, a large cavity portion for accommodating large-size second terminal fittings, and a recess in which a protrusion is arranged. Each of the small cavity portion and the large cavity portion has a front surface on a front side in a fitting direction into the receptacle and an end surface on one end side intersecting the fitting direction. The end surface of the small cavity portion is arranged to drop in a height direction from the end surface of the large cavity portion. The recess is defined by a side surface in the height direction of the large cavity portion and the end surface of the small cavity portion and open toward the front side and the one end side.

### TECHNICAL FIELD

The present disclosure relates to a connector.

### BACKGROUND

A connector described in Patent Document 1 is provided with a female housing and a male housing. The female housing includes a receptacle. A guide rib is formed on the inner surface of a side wall of the receptacle. The male housing includes a housing body to be fit into the receptacle. A guide groove for guiding the guide rib is formed in the outer surface of a side wall of the housing body. Connectors including such parts corresponding to the guide rib and the guide groove are also disclosed in Patent Document 2 and 3.

### PRIOR ART DOCUMENT

### Patent Document

Patent Document 1: JP H11-144800 A
Patent Document 2: JP 2000-331747 A
Patent Document 3: JP 2015-072871 A

### SUMMARY OF THE INVENTION

### Problems to be Solved

In the case of Patent Document 1, a plurality of ribs are formed on the outer surface of the side wall of the housing body. A mere recess is formed together with the guide groove between the respective ribs. Thus, a space is wasted at the position of the recess and there is a concern that the male housing is enlarged in a height direction.

Accordingly, the present disclosure aims to provide a connector excellent in space efficiency.

### Means to Solve the Problem

The present disclosure is directed to a connector with a first housing and a second housing, the first housing including a receptacle and a protrusion projecting into the receptacle, the second housing including a housing body to be fit into the receptacle, the housing body including a small cavity portion for accommodating small-size second terminal fittings, a large cavity portion for accommodating large-size second terminal fittings and a recess, the protrusion being arranged in the recess, each of the small cavity portion and the large cavity portion having a front surface on a front side in a fitting direction into the receptacle and an end surface on one end side intersecting the fitting direction, the end surface of the small cavity portion being arranged to drop in a height direction from the end surface of the large cavity portion, and the recess being defined by a side surface in the height direction of the large cavity portion and the end surface of the small cavity portion, the recess being open toward the front side and the one end side.

### Effect of the Invention

According to the present disclosure, it is possible to provide a connector excellent in space efficiency.

### BRIEF DESCRIPTION OF THE DRAWINGS

FIG. 1 is a section showing a state where a first connector and a second connector are connected to each other in one embodiment.

FIG. 2 is a front view of the first connector.

FIG. 3 is an enlarged perspective view of a part of the first connector when viewed obliquely from below.

FIG. 4 is a perspective view of a second housing when viewed obliquely from above.

FIG. 5 is a front view of the second housing.

FIG. 6 is a perspective view of a housing body when viewed obliquely from above.

FIG. 7 is a plan view of the housing body.

FIG. 8 is a plan view showing a state where a lever is held at an initial position with respect to the housing body.

FIG. 9 is a perspective view of a retainer when viewed obliquely from above.

### DETAILED DESCRIPTION TO EXECUTE THE INVENTION

### Description of Embodiments of Present Disclosure

First, embodiments of the present disclosure are listed and described.

(1) The connector of the present disclosure is provided with a first housing and a second housing, the first housing including a receptacle and a protrusion projecting into the receptacle, the second housing including a housing body to be fit into the receptacle, the housing body including a small cavity portion for accommodating small-size second terminal fittings, a large cavity portion for accommodating large-size second terminal fittings and a recess, the protrusion being arranged in the recess, each of the small cavity portion and the large cavity portion having a front surface on a front side in a fitting direction into the receptacle and an end surface on one end side intersecting the fitting direction, the end surface of the small cavity portion being arranged to drop in a height direction from the end surface of the large cavity portion, and the recess being defined by a side surface in the height direction of the large cavity portion and the end surface of the small cavity portion, the recess being open toward the front side and the one end side.

According to the above configuration, since the recess is open not only toward the front side, but also toward the one end side, a mold part for forming the recess needs not be thin. Further, since the protrusion to be arranged in the recess can be thickened, the strength of the protrusion can be ensured. Furthermore, since the recess can be formed in a height range of the large cavity portion, space efficiency is excellent.

(2) Preferably, the second housing includes a front portion for covering the front surface of the small cavity portion, the front portion includes a locking portion and the housing body includes a locked portion to be locked by the locking portion, and the locked portion is formed to be open in the end surface of the small cavity portion.

According to the above configuration, since a mold part for forming the locked portion can be set on the one end side of the housing body, the moldability of the locked portion can be improved as compared to the case where the locked portion is formed inside the small cavity portion.

(3) A lever to be supported on the housing body may be provided, the receptacle may include a columnar lever shaft for advancing fitting of the housing body by being engaged with the lever, and the lever shaft may be bridged from the receptacle to the protrusion.

According to the above configuration, the protrusion is reinforced by the lever shaft and hardly deformed.

(4) A plurality of the receptacles may be provided in the first housing, and the protrusions may be formed to have different external dimensions in the plurality of respective receptacles.

According to the above configuration, if an attempt is made to fit a second housing different from the originally designed one into the receptacle, the protrusion interferes with the front surface or the like of the second housing and cannot be arranged in the recess. Thus, the second housing can be prevented from being erroneously fit into the receptacle.

### Details of Embodiments of Present Disclosure

A specific example of the present disclosure is described below with reference to the drawings. Note that the present invention is not limited to this illustration, but is represented by claims and intended to include all changes in the scope of claims and in the meaning and scope of equivalents.

### Embodiment

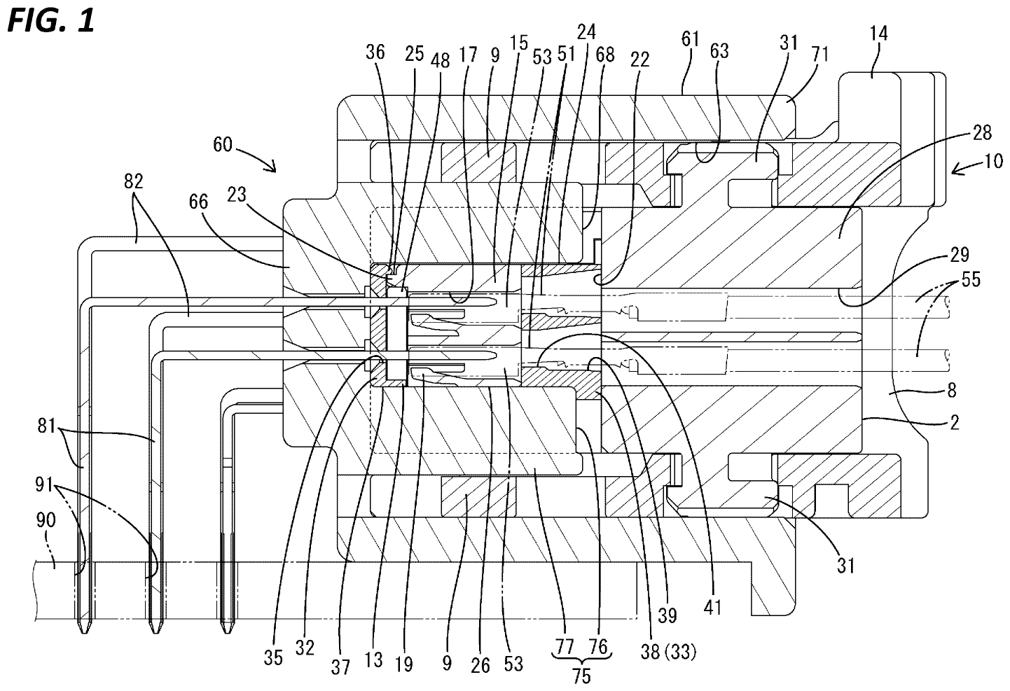

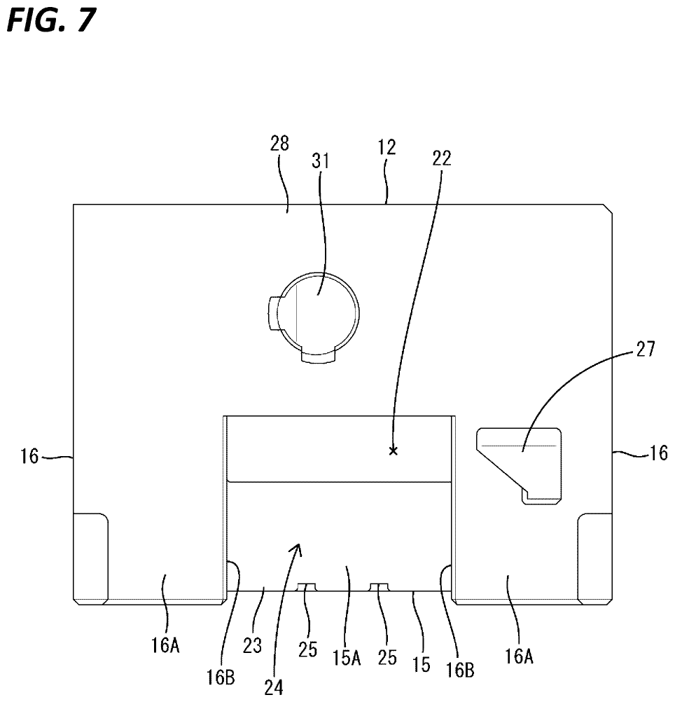

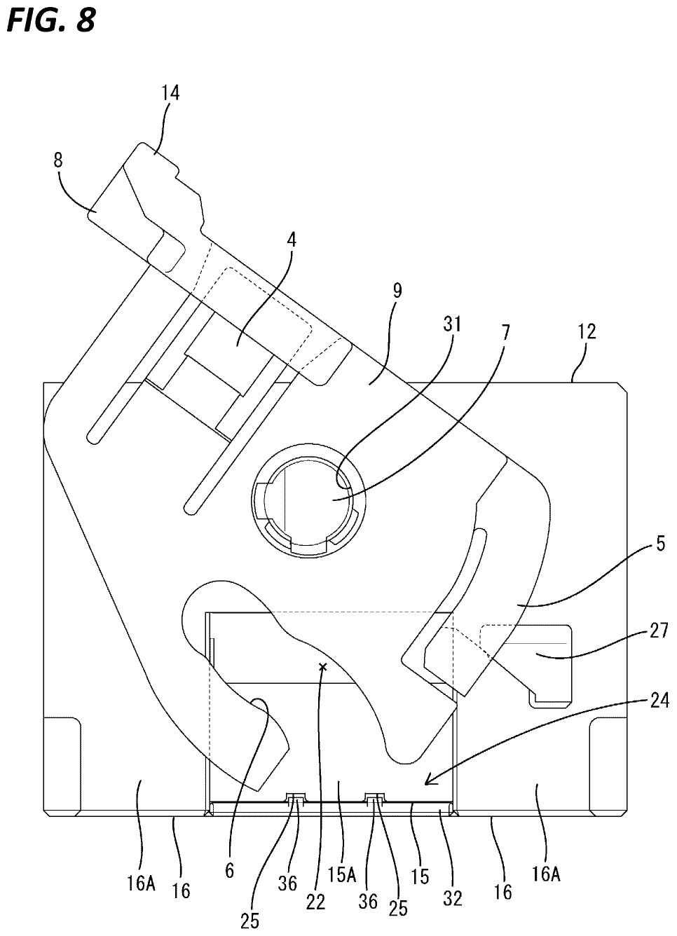

One embodiment of the present disclosure is provided with a first connector 60 and a second connector 10 connectable to each other as shown in FIG. 1. Note that, in the following description, surface sides facing each other when the connection of the first and second connectors 60, 10 is started are referred to as front sides concerning a front-rear direction. A vertical direction is based on a vertical direction of each figure except FIGS. 7 and 8. The vertical direction is synonymous with a height direction. The vertical direction is not necessarily limited to a direction of gravity in a state where the connector is installed in an unillustrated vehicle or the like. A lateral direction is a direction orthogonal to the front-rear direction and height direction, and synonymous with a width direction.

### (First Connector)

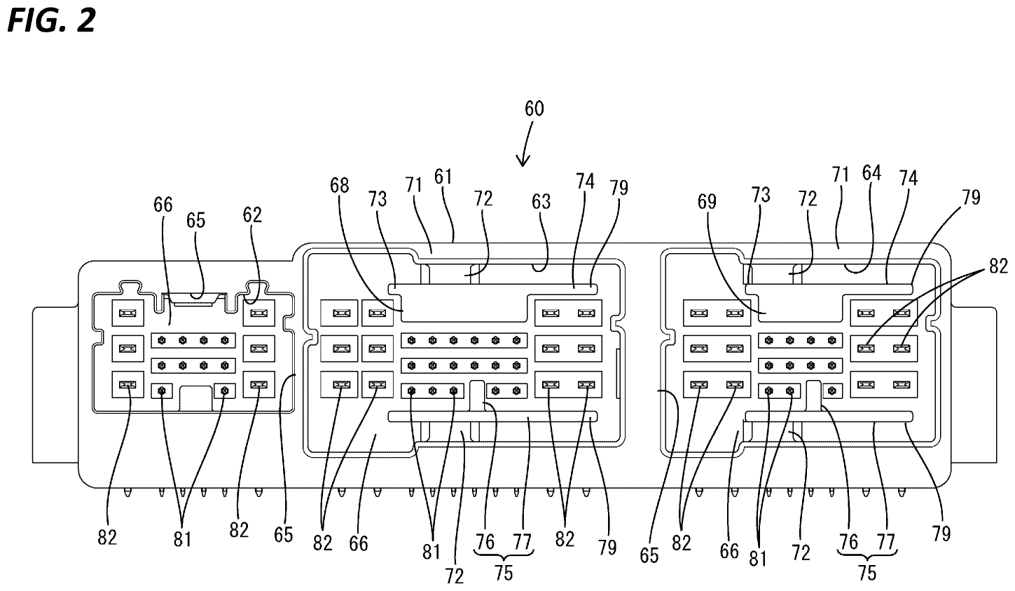

The first connector 60 includes a first housing 61 made of synthetic resin and first terminal fittings 81, 82 made of electrically conductive metal. As shown in FIG. 2, the first housing 61 includes a plurality of receptacles 62, 63 and 64. In the case of this embodiment, three receptacles 62, 63 and 64 are provided side by side in the width direction in the first housing 61. Each of the receptacles 62, 63, 64 has a rectangular cross-section and is open forward. The receptacles 62, 63 and 64 adjacent in the width direction are partitioned by partition walls 65 along the vertical direction.

A plurality of the first terminal fittings 81, 82 are in the form of pins or tabs and mounted in the first housing 61. A front end part of each first terminal fitting 81, 82 projects into the receptacle 62, 63, 64. An intermediate part (part except the front end part and a rear end part) of each first terminal fitting 81, 82 is passed through a back wall 66 of the receptacle 62, 63, 64. The rear end part of each first terminal fitting 81, 82 is bent downward behind the receptacle 62, 63, 64 and inserted into a through-hole 91 of a circuit board 90 and solder-connected (see FIG. 1).

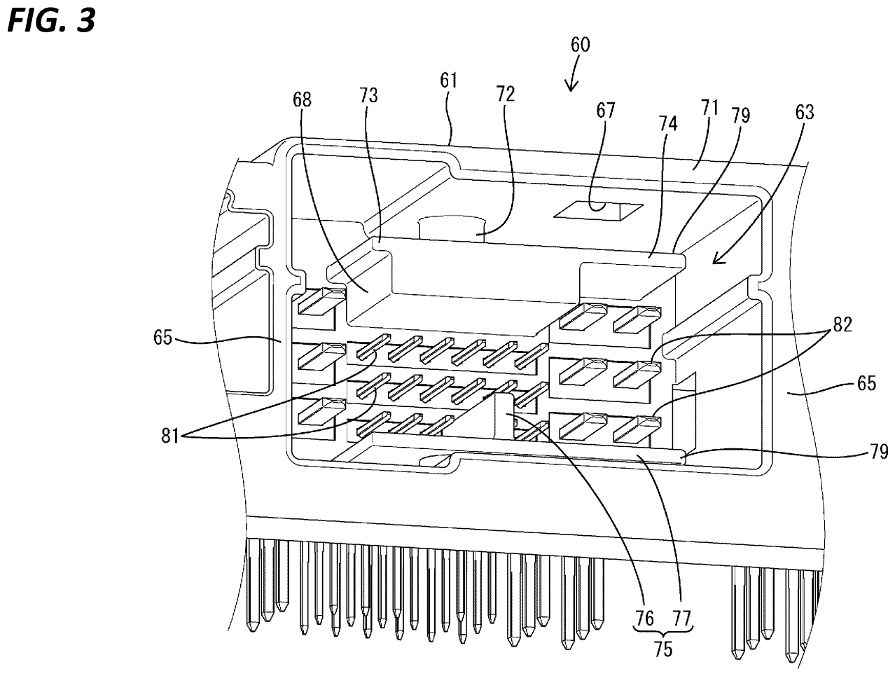

The respective first terminal fittings 81, 82 include a plurality of small-size first terminal fittings 81 in the form of pins and a plurality of large-size first terminal fittings 82 wider than the small-size first terminal fittings 81 and in the form of tabs as shown in FIG. 3. The respective small-size first terminal fittings 81 are arranged in widthwise central parts of the receptacles 62, 63 and 64 of the first housing 61. The respective large-size first terminal fittings 82 are arranged in both widthwise end parts of the receptacles 62, 63 and 64 of the first housing 61.

Rectangular lock holes 67 are formed to penetrate through upper walls 71 of two right receptacles 63, 64 of FIG. 2, out of the respective receptacles 62, 63 and 64 (see FIG. 3). A lock arm 4 of a lever 14 to be described later is locked into the lock hole 67. Further, protrusions 68, 69 are respectively arranged in the two right receptacles 63, 64 of FIG. 2. Note that, in the following description of the structure of the first connector 60, the receptacles mean the two right receptacles 63, 64 of FIG. 2 unless otherwise specified.

The protrusion 68, 69 is in the form of a rib long in the width direction and projects from an upper end part of the back wall 66 of the receptacle 63, 64. The protrusion 68, 69 is arranged to cover, from above, a location where the respective small-size first terminal fittings 81 are disposed in the receptacle 63, 64. Further, the protrusion 68, 69 is arranged between locations where the respective large-size first terminal fittings 82 are disposed in the receptacle 63, 64, and includes a part arranged at the same height position as the respective large-size first terminal fittings 82 located in the uppermost stage.

As shown in FIG. 2, the protrusions 68, 69 arranged in the two right receptacles 63, 64 have mutually different widths. Specifically, the protrusion 68 arranged in the middle receptacle 63 is formed to be wider than the protrusion 69 arranged in the receptacle 64 on a right side.

A lever shaft 72 is formed between the protrusion 68, 69 and the upper wall 71 of the receptacle 63, 64. The lever shaft 72 has a cylindrical shape along the vertical direction and has a lower end coupled to the protrusion 68, 69 and an upper end coupled to the upper wall 71 of the receptacle 63, 64. The lever shaft 72 is engaged with a later-described cam groove 6 of the lever 14.

As shown in FIG. 2, left and right second protrusions 73, 74 protruding toward both widthwise sides from an upper end part of the protrusion 68, 69 are arranged in the receptacle 63, 64. The respective second protrusions 73, 74 are thinner in the vertical direction than the protrusion 68, 69. Each second protrusion 73, 74 is in the form of a rib long in the width direction, and projects from an upper end part of the back wall 66 of the receptacle 63, 64. The upper surface of each second protrusion 73, 74 is connected to the upper surface of the protrusion 68, 69 in the width direction without any step. The second protrusion 74 on the right side of FIG. 2 is arranged to cover, from above, the location where the respective large-size first terminal fittings 82 are disposed in the receptacle 63, 64.

As shown in FIG. 2, a third protrusion 75 is also arranged in the receptacle 63, 64. The third protrusion 75 projects from a lower end part of the back wall 66 of the receptacle 63, 64. The third protrusion 75 is T-shaped in a front view, and includes a vertical rib 76 extending in the height direction and a horizontal rib 77 extending in the width direction. The horizontal rib 77 is longer than the vertical rib 76, and arranged to cover, from below, the location where the respective small-size first terminal fittings 81 are disposed in the receptacle 63, 64. The respective small-size first terminal fittings 81 are protected by being sandwiched in the vertical direction between the protrusion 68, 69 and the horizontal rib 77. A lever shaft 72 is also formed between the horizontal rib 77 and the lower wall of the receptacle 63, 64. A part of the horizontal rib 77 extending rightward in FIG. 2 from the vertical rib 76 is arranged to cover, from below, the location where the respective large-size first terminal fittings 82 are disposed.

Note that the front ends of the protrusions 68, 69, the second protrusions 73, 74 and the third protrusions 75 are arranged forward of those of the respective first terminal fittings 81, 82. A gap between the protrusion 68, 69 and the third protrusion 75 is set to 10 mm or less. Thus, the fingertip of a worker or the like can avoid contact with the front ends of the respective small-size first terminal fittings 81 while being held in contact with the front end of the protrusion 68, 69 and the front end of the third protrusion 75.

Further, the part of the horizontal rib 77 extending rightward in FIG. 2 from the vertical rib 76 and the second protrusion 74 on the right side of FIG. 2 serve as a releasing portion 79 for releasing a locked state of the lever 14 at an initial position to be described later.

### (Second Connector)

The second connector 10 includes a second housing 11 made of synthetic resin and second terminal fittings 51, 52 made of electrically conductive metal. The second connector 10 of this embodiment is fit into the middle receptacle 63 of FIG. 2. Note that, in the following description, the receptacle serving as a fitting partner of the second connector 10 (also a second housing 11) means the middle receptacle 63 of FIG. 2 unless otherwise specified.

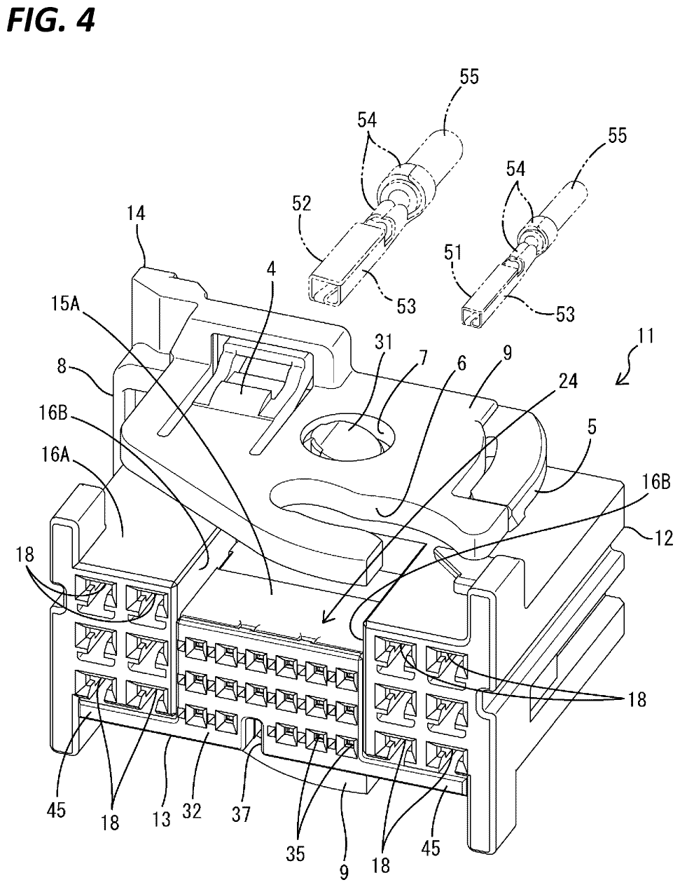

As shown in FIG. 4, the second terminal fitting 51, 52 includes a tubular connecting portion 53 and a barrel portion 54 connected behind the connecting portion 53. The first terminal fitting 81, 82 is inserted and connected in the connecting portion 53. The barrel portion 54 is electrically and mechanically connected to an end part of a wire 55. The second terminal fittings 51, 52 include a plurality of small-size second terminal fittings 51 to be connected to the respective small-size first terminal fittings 81 and a plurality of large-size second terminal fittings 52 larger than the small-size second terminal fittings 51 and to be connected to the respective large-size first terminal fittings 82.

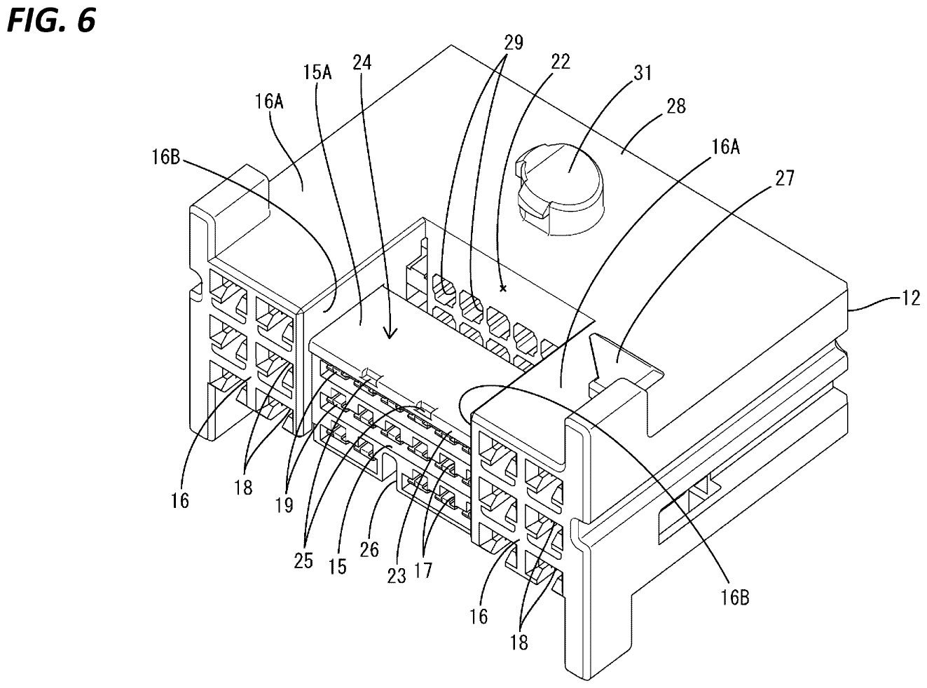

As shown in FIG. 4, the second housing 11 includes a housing body 12, a retainer 13 and the lever 14. As shown in FIG. 6, the housing body 12 includes a small cavity portion 15 in a widthwise central part and large cavity portions 16 in both widthwise end parts. The small cavity portion 15 is formed with a plurality of small cavities 17 penetrating in the front-rear direction at positions corresponding to the respective small-size first terminal fittings 81. The large cavity portion 16 is formed with a plurality of large cavities 18 penetrating in the front-rear direction at positions corresponding to the respective large-size first terminal fittings 82.

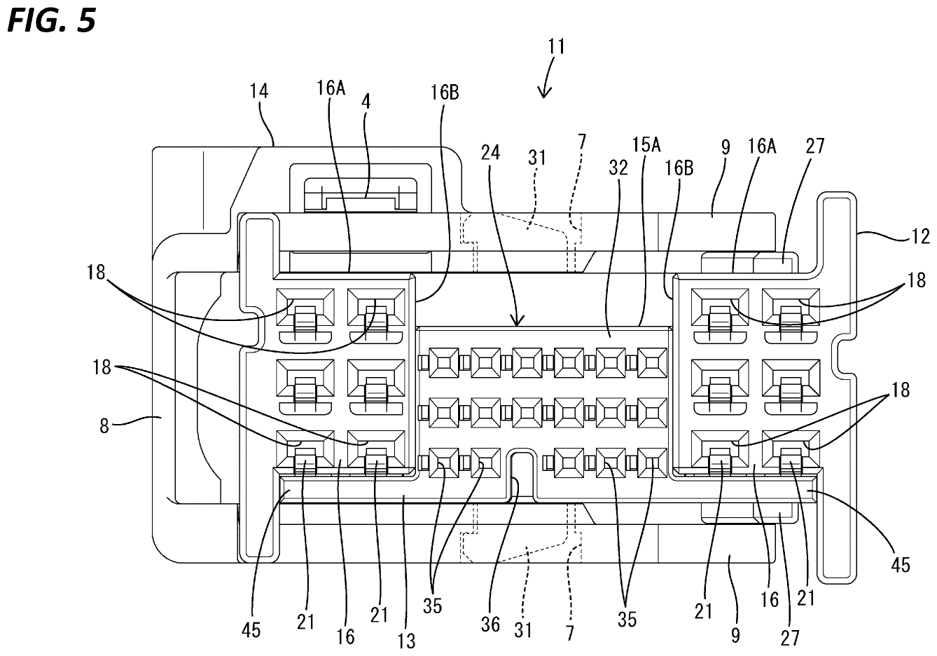

An opening diameter of each large cavity 18 is larger than that of each small cavity 17. A small-size locking lance 19 is formed to project on the lower surface of the inner wall of each small cavity 17. As shown in FIG. 5, a large-size locking lance 21 larger than the small-size locking lance 19 is formed to project on the lower surface of the inner wall of each large cavity 18.

As shown in FIG. 1, the small-size second terminal fitting 51 is inserted into each small cavity 17. The small-size second terminal fitting 51 is primarily locked by the small-size locking lance 19. Although not shown, the large-size second terminal fitting 52 is inserted into each large cavity 18. The large-size second terminal fitting 52 is primarily locked by the large-size locking lance 21.

As shown in FIGS. 6 and 7, the housing body 12 is formed with a retainer mounting hole 22. The retainer mounting hole 22 has a rectangular cross-sectional shape long in the width direction and penetrates through a rear end part of the small cavity portion 15 in the front-rear direction in the widthwise central part of the housing body 12.

The front surface (surface facing forward) of the small cavity portion 15 is arranged to be recessed rearward from the front surfaces of the large cavity portion 16. As shown in FIG. 6, a rib-like stopper portion 23 extending in the width direction is formed on an upper end part of the front surface of the small cavity portion 15. The stopper portion 23 has a function of stopping a later-described front portion 32 of the retainer 13 in contact therewith.

An upper surface 15A (end surface on an upper side) of the small cavity portion 15 is arranged to slightly drop downward from an upper surface 16A of each large cavity portion 16. The housing body 12 is formed with a recess 24 by elevation differences (steps) between the upper surfaces 16A of the respective large cavity portions 16 and the upper surface 15A of the small cavity portion 15.

As shown in FIG. 6, the recess 24 is open forward and upward of the housing body 12. Both side surfaces of the recess 24 are side surfaces 16B of the respective large cavity portions 16 facing each other and, as shown in FIG. 5, vertically arranged in the height direction. The bottom surface (except a rear end part) of the recess 24 is the upper surface 15A of the small cavity portion 15 and horizontally arranged in the width direction. As shown in FIGS. 6 and 7, the rear end part of the recess 24 communicates with the retainer mounting hole 22 and the bottom surface is closed by a later-described small cavity side rear portion 38 inserted into the retainer mounting hole 22. The rear surface of the recess 24 is closed by a cavity rear portion 28 to be described later. With the lever 14 assembled with the housing body 12, the recess 24 is partially covered from above by a later-described arm portion 9 of the lever 14 as shown in FIGS. 4 and 8.

As shown in FIGS. 6 and 7, a pair of locked portions 25 are formed to be open in the upper surface 15A of the small cavity portion 15 (also the bottom surface of the recess 24). The respective locked portions 25 are shaped by cutting the front end of an upper part of the stopper portion 23 into a recess shape and arranged at an interval in the width direction. The front portion 32 of the retainer 13 is locked to the respective locked portions 25 (see FIGS. 1 and 8).

As shown in FIG. 6, a fitting groove 26 is formed to be open in the lower surface of the small cavity portion 15. The fitting groove 26 has a cross-sectional shape long in the vertical direction and is arranged at a position closer to a left side of FIG. 6 than a widthwise center of the small cavity portion 15. The fitting groove 26 penetrates through the small cavity portion 15 in the front-rear direction. The vertical rib 76 of the third protrusion 75 is fit into the fitting groove 26.

As shown in FIG. 5, a temporary holding portion 27 is formed to project on each of the upper surface 16A and the lower surface of the right large cavity portion 16. Each temporary holding portion 27 has a function of holding the lever 14 at the initial position to be described later with respect to the housing body 12 by being engaged with the arm portion 9 of the lever 14 (see FIG. 8).

As shown in FIGS. 6 and 7, the housing body 12 includes the cavity rear portion 28 facing the small cavity portion 15 via the retainer mounting hole 22 behind the small cavity portion 15. As shown in FIG. 6, a plurality of rear cavities 29 are formed to penetrate through the cavity rear portion 28 in the front-rear direction. Each rear cavity 29 is coaxially connected to each small cavity 17 in the front-rear direction via the retainer mounting hole 22. The wire 55 connected to the small-size second terminal fitting 51 is arranged in each rear cavity 29 (see FIG. 1). The upper and lower surfaces of the cavity rear portion 28 are continuous with the upper surface 16A and the lower surface of the large cavity portion 16 without any step. As shown in FIGS. 1 and 5, a support shaft 31 is formed to project on each of the upper and lower surfaces of the cavity rear portion 28. Each support shaft 31 rotatably supports the lever 14.

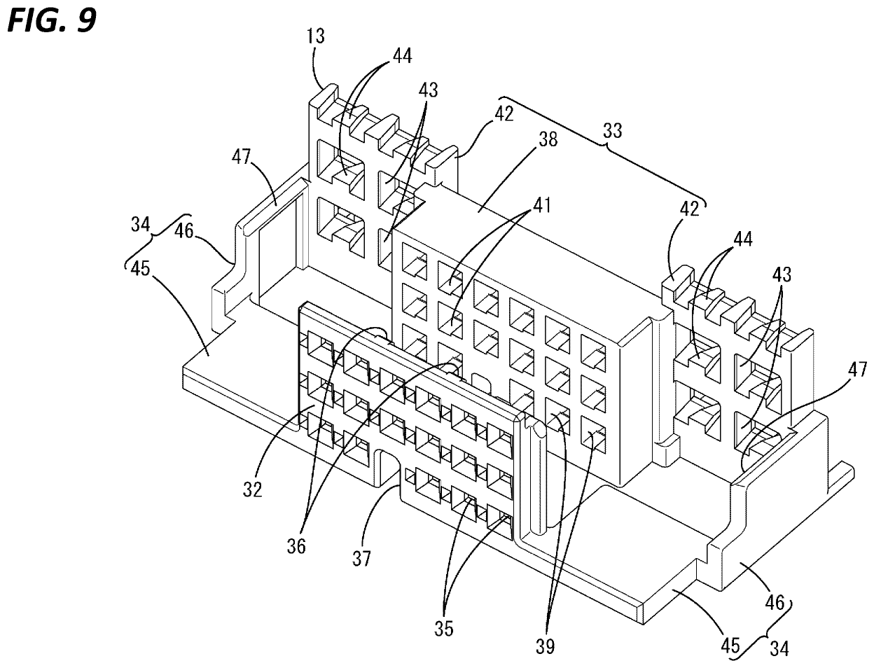

As shown in FIG. 9, the retainer 13 includes the front portion 32 located on a front side, a rear part 33 located on a rear side and a coupling portion 34 coupling the front portion 32 and the rear portion 33. The retainer 13 is assembled with the housing body 12 from below and movable between a temporary locking position and a complete locking position with respect to the housing body 12.

The front portion 32 is plate-like and arranged with plate surfaces facing forward and rearward. As shown in FIGS. 1 and 8, the front portion 32 is arranged to cover the front surface of the small cavity portion 15. As shown in FIG. 9, the front portion 32 includes a plurality of insertion holes 35 at positions corresponding to the respective small cavities 17. A front end part of the small-size first terminal fitting 81 is inserted into each insertion hole 35 from front (see FIG. 1). The upper end of the front portion 32 is formed with a pair of locking portions 36 projecting rearward. The respective locking portions 36 are claw-like and arranged at an interval in the width direction on the upper end of the front portion 32. As shown in FIG. 8, each locking portion 36 is locked to each locked portion 25.

As shown in FIG. 9, a front fitting groove 37 is formed to be open at a position corresponding to the fitting groove 26 in the lower surface of the front portion 32. The front fitting groove 37 has a cross-sectional shape long in the vertical direction and penetrates through the front portion 32 in the front-rear direction. The vertical rib 76 of the third protrusion 75 is fit into the front fitting groove 37.

The rear portion 33 is fit into the retainer mounting hole 22 of the housing body 12 (see FIG. 1). As shown in FIG. 9, the rear portion 33 has a larger diameter in the front-rear direction than the front portion 32 and includes the small cavity side rear portion 38 facing the front portion 32 behind the front portion 32. The small cavity side rear portion 38 includes a plurality of small through holes 39 at positions corresponding to the respective small cavities 17 and the respective insertion holes 35. The barrel portion 54 of the small-size second terminal fitting 51 is inserted into each small through hole 39. A plurality of small retaining portions 41 are formed to project on the lower surfaces of the inner walls of the respective small through holes 39. The small retaining portion 41 locks the small-size second terminal fitting 51 at the complete locking position (see FIG. 1).

As shown in FIG. 9, the rear portion 33 includes a pair of large cavity side rear portions 42 protruding toward both widthwise sides from the rear end of the small cavity side rear portion 38. Each large cavity side rear portion 42 is wall-like and arranged with wall surfaces facing forward and rearward. Each large cavity side rear portion 42 includes a plurality of large through holes 43 at positions corresponding to the respective large cavities 18. An opening diameter of each large through hole 43 is larger than that of each small through hole 39. Although not shown, the wire 55 connected to the large-size second terminal fitting 52 is inserted into each large through hole 43. A plurality of large retaining portions 44 are formed to project on the lower surfaces of the inner walls of the respective large through holes 43 and the upper end surface of each large cavity side rear portion 42. The large retaining portion 44 locks the large-size second terminal fitting 52 at the complete locking position.

As shown in FIG. 9, the coupling portion 34 includes a pair of front coupling portions 45 protruding toward both widthwise sides from the lower end of the front portion 32. Each front coupling portion 45 is plate-like and arranged with plate surfaces facing upward and downward. As shown in FIG. 5, each front coupling portion 45 is arranged along the lower surface of each large cavity portion 16. Further, as shown in FIG. 9, the coupling portion 34 includes a pair of bridge portions 46 bridged between the respective front coupling portions 45 and the respective large cavity side rear portions 42 in both widthwise end parts of the retainer 13. Each bridge portion 46 is plate-like and arranged with plate surfaces facing laterally. A pair of side locking portions 47 are formed on the inner surfaces of the respective bridge portions 46. Each side locking portion 47 is in the form of a rib extending in the front-rear direction and locked to unillustrated temporary locking portion and complete locking portion formed on the housing body 12.

By locking the respective side locking portions 47 to the temporary locking portions, the retainer 13 is held at the temporary locking position with respect to the housing body 12. By applying an upward pushing force to the retainer 13, a locked state of the respective side locking portions 47 and the temporary locking portions is released and the retainer 13 becomes movable to the complete locking position. When the retainer 13 reaches the complete locking position, a rib-like portion 48 formed to extend in the vertical direction on the rear surface of the front portion 32 is stopped in contact with the stopper portion 23 from below as shown in FIG. 1. Then, the locking portions 36 are locked to the locked portions 25 and the respective side locking portions 47 are locked to the complete locking portions, whereby the retainer 13 is held at the complete locking position with respect to the housing body 12. Further, at the complete locking position, the respective small retaining portions 41 and the respective large retaining portions 44 are arranged to be lockable to the connecting portions 53 of the small-size second terminal fittings 51 and the connecting portions 53 of the large-size second terminal fittings 52 from behind. The respective second terminal fittings 51, 52 are secondarily locked by the respective small retaining portions 41 and the respective large retaining portions 44.

As shown in FIG. 5, the lever 14 is in the form of a gate-shaped plate and includes a pair of the arm portions 9 vertically facing each other and an operating portion 8 connecting the respective arm portions 9 and extending along the vertical direction. The respective arm portions 9 are arranged to cover the upper and lower surfaces of the housing body 12. A circular bearing portion 7 is formed to penetrate through each arm portion 9. The support shaft 31 is fit to each bearing portion 7. The lever 14 is rotatable about the respective support shafts 31 fit to the respective bearing portions 7 between the initial position and a connection position with respect to the housing body 12. As shown in FIGS. 4 and 8, each arm portion 9 is formed with a cam groove 6. The entrance of the cam groove 6 is open in the outer peripheral edge of the arm portion 9. Each arm portion 9 includes a deflectable and deformable resilient lock portion 5 on the outer peripheral edge on an end side distant from the operating portion 8. Further, out of the arm portions 9, the upper arm portion 9 is formed with the lock arm 4 deflectable and deformable in the vertical direction.

As shown in FIG. 8, when the lever 14 is at the initial position, each resilient lock portion 5 is locked to each temporary holding portion 27 to restrict the rotation of the lever 14 to the complete locking position. Although not shown, if the second housing 11 is lightly fit into the receptacle 63 of the first housing 61, each lever shaft 72 enters the entrance of each cam groove 6 and each resilient lock portion 5 interferes with each releasing portion 79 of the first housing 61 to be deflected and deformed, whereby a locked state of each resilient lock portion 5 and each temporary holding portion 27 is released. In this way, the lever 14 becomes rotatable to the complete locking position. Subsequently, the lever 14 is rotated toward the connection position by pinching the operating portion 8. In the process of rotating the lever 14, each lever shaft 72 slides on the groove surface of each cam groove 6 and the connection of the first and second housings 61, 11 proceeds. When the lever 14 reaches the connection position, the lock arm 4 is resiliently locked into the lock hole 67 and the first and second housings 61, 11 are held in a connected state.

### (Overall Structures of First Connector and Second Connector)

The protrusion 68 is fit into the recess 24 with the second housing 11 fit in the receptacle 63 of the first housing 61 (see FIG. 1). Further, the vertical rib 76 is fit into the front fitting groove 37 and the fitting groove 26. If the second housing 11 is in a connection posture inclined in a direction intersecting the front-rear direction with respect to the first housing 61, the front portion 32 and the like of the second housing 11 interfere with the protrusion 68 and a fitting operation of the second housing 11 is restricted. At this time, since the second housing 11 can be prevented from contacting the small-size first terminal fittings 81, the deformation of the small-size first terminal fittings 81 can be avoided.

The recess 24 is open forward and upward of the housing body 12. Thus, an unillustrated mold part for molding the recess 24 can increase a thickness of the housing body 12 upward. Further, a thickness of the protrusion 68 to be fit into the recess 24 can also be increased upward. Thus, in this embodiment, the strength of the protrusion 68 can be ensured without reducing an arrangement region of the respective small-size first terminal fittings 81.

Further, the recess 24 is defined by the side surfaces 16B in the height direction of the respective large cavity portions 16 and the upper surface 15A of the small cavity portion 15. As shown in FIGS. 4 to 6, upper end parts (large cavities 18 in the uppermost stage) of the respective large cavity portions 16 are arranged on both left and right sides of the recess 24. That is, the recess 24 is arranged at a height position overlapping the respective large cavity portions 16 (large cavities 18 in the uppermost stage). Thus, the both left and right sides of the recess 24 are efficiently utilized and space efficiency is excellent. Further, the enlargement of the connector in the height direction can be suppressed.

Further, as shown in FIG. 6, the locked portions 25 to be locked by the locking portions 36 of the front portion 32 of the retainer 13 are formed to be open in the upper surface 15A of the small cavity portion 15 (bottom surface of the recess 24). An unillustrated mold part for molding the locked portions 25 can increase a thickness of the small cavity portion 15 upward. Thus, the moldability of the locked portions 25 can be improved.

Further, since the lever shaft 72 is bridged between the upper wall 71 of the receptacle 63 and an intermediate part of the protrusion 68, the protrusion 68 is reinforced by the lever shaft 72 and hardly deformed.

Furthermore, in the case of this embodiment, the protrusions 68, 69 having different external dimensions are respectively formed in the two right receptacles 63, 64 of FIG. 2. Thus, if an attempt is, for example, made to fit a second housing originally designed to be fit into the receptacle 64 at the right end of FIG. 2 into the middle receptacle 63 of FIG. 2, the protrusion 68 formed in the receptacle 63 interferes with the front surface of the second housing and a fitting operation of the second housing is restricted. Thus, the second housing can be prevented from being erroneously fit into the receptacle 63.

### Other Embodiments of Present Disclosure

The embodiment disclosed this time should be considered illustrative in all aspects, rather than restrictive.

In the case of the above embodiment, the recess is defined by the side surfaces of the two large cavity portions and the upper surface of the small cavity portion. However, as another embodiment, a recess may be defined by the side surface of one large cavity portion and the upper surface of the small cavity portion, and open toward a side facing the side surface of the one large cavity portion.

In the case of the above embodiment, the protrusions formed in the plurality of receptacles have mutually different widths. However, as another embodiment, protrusions formed in a plurality of receptacles may have mutually different vertical thicknesses.

In the case of the above embodiment, the front portion is formed in the retainer, together with the rear portion having a retainer function (function of locking the second terminal fittings). However, as another embodiment, a front portion may be formed separately from a rear portion having a retainer function. Alternatively, a front portion itself may have a retainer function.

In the case of the above embodiment, the first terminal fitting is inserted and connected to the through-hole of the circuit board. However, as another embodiment, a first terminal fitting may be arranged along a surface of a circuit board and connected to an electrically conductive portion formed on the surface of the circuit board. Alternatively, as another embodiment, a first terminal fitting may be connected not to a circuit board, but to an end part of a wire.

### LIST OF REFERENCE NUMERALS

4 . . . lock arm
5 . . . resilient lock portion
6 . . . cam groove
7 . . . bearing portion
8 . . . operating portion
9 . . . arm portion
10 . . . second connector
11 . . . second housing
12 . . . housing body
13 . . . retainer
14 . . . lever
15 . . . small cavity portion
15A upper surface of small cavity portion (end surface of small cavity portion)
16 . . . large cavity portion
16A . . . upper surface of large cavity portion
16B . . . side surface in height direction of large cavity portion
17 . . . small cavity
18 . . . large cavity
19 small-size locking lance
21 . . . large-size locking lance
22 . . . retainer mounting hole
23 . . . stopper portion
24 . . . recess
25 . . . locked portion
26 . . . fitting groove
27 . . . temporary holding portion
28 . . . cavity rear portion
29 . . . rear cavity
31 . . . support shaft
32 . . . front portion
33 . . . rear portion
34 . . . coupling portion
35 . . . insertion hole
36 . . . locking portion
37 . . . front fitting groove
38 . . . small cavity side rear portion
39 . . . small through hole
41 . . . small retaining portion
42 . . . large cavity side rear portion
43 . . . large through hole
44 . . . large retaining portion
45 . . . front coupling portion
46 . . . bridge portion
47 . . . side locking portion
48 . . . rib-like portion
51, 52 . . . second terminal fitting
53 . . . connecting portion
54 . . . barrel portion
55 . . . wire
60 . . . first connector
61 . . . first housing
62, 63, 64 . . . receptacle
65 . . . partition wall
66 . . . back wall
67 . . . lock hole
68, 69 . . . protrusion
71 . . . upper wall of receptacle
72 . . . lever shaft
73, 74 . . . second protrusion
75 . . . third protrusion
76 . . . vertical rib
77 horizontal rib
79 . . . releasing portion
81, 82 . . . first terminal fitting
90 . . . circuit board
91 . . . through-hole

1. A connector, comprising a first housing and a second housing,
the first housing including a receptacle and a protrusion projecting into the receptacle,
the second housing including a housing body to be fit into the receptacle,
the housing body including a small cavity portion for accommodating small-size second terminal fittings, a large cavity portion for accommodating large-size second terminal fittings and a recess, the protrusion being arranged in the recess,
each of the small cavity portion and the large cavity portion having a front surface on a front side in a fitting direction into the receptacle and an end surface on one end side intersecting the fitting direction,
the end surface of the small cavity portion being arranged to drop in a height direction from the end surface of the large cavity portion, and
the recess being defined by a side surface in the height direction of the large cavity portion and the end surface of the small cavity portion, the recess being open toward the front side and the one end side.

2. The connector of claim 1, wherein:
the second housing includes a front portion for covering the front surface of the small cavity portion,
the front portion includes a locking portion and the housing body includes a locked portion to be locked by the locking portion, and
the locked portion is formed to be open in the end surface of the small cavity portion.

3. The connector of claim 1, comprising a lever to be supported on the housing body, wherein:
the receptacle includes a columnar lever shaft for advancing fitting of the housing body by being engaged with the lever, and
the lever shaft is bridged from the receptacle to the protrusion.

4. The connector of claim 1, wherein:
a plurality of the receptacles are provided in the first housing, and
the protrusions are formed to have different external dimensions in the plurality of respective receptacles.
